(19) United States
(12) Patent Application Publication
(10) Pub. No.: US 2025/0214629 A1
(43) Pub. Date: Jul. 3, 2025

(54) Method for Monitoring an at Least Highly Automated Driving Mode of a Vehicle With Checking of a Safe Operating State Under Consideration of a Vertical Dynamic, Computing Device, and Driver Assistance System

(71) Applicant: Bayerische Motoren Werke Aktiengesellschaft, Munchen (DE)

(72) Inventor: Michael MANZ, Steinhoering (DE)

(21) Appl. No.: 18/853,454

(22) PCT Filed: Apr. 4, 2023
(86) PCT No.: PCT/EP2023/058891

§ 371 Date: Oct. 2, 2024

(30) Foreign Application Priority Data
Apr. 11, 2022 (DE) 10 2022 108 787.5

(51) Int. Cl. B60W 60/00

(52) U.S. Cl. CPC B60W 60/0053; B60W 60/0015; B60W 2510/22; B60W 2520/105; B60W 2552/00

(57) ABSTRACT

A method for monitoring an at least highly automated driving mode of a vehicle includes the steps of: activating the at least highly automated driving mode of the vehicle; checking whether a defined safe operating state of the vehicle is provided during the at least highly automated driving mode; initiating a deactivation of the at least highly automated driving mode if the defined safe operating state is not provided; maintaining the at least highly automated driving mode if the defined safe operating state is provided; receiving at least one sensor signal which describes a vertical dynamic of the vehicle; and defining the safe operating state as a function of the at least one received sensor signal.

### BACKGROUND AND SUMMARY

The present invention relates to a method for monitoring an at least highly automated driving mode of a vehicle. In addition, the present invention relates to a computing device for a driver assistance system. Moreover, the present invention relates to a driver assistance system for a vehicle having such a computing device. In addition, the present invention relates to a computer product.

Different driver assistance systems are known from the prior art, using which automated driving or an automated driving mode of the vehicle can be enabled. The term “automated driving” is understood in the context of the document as driving with automated longitudinal and/or lateral control. The term “automated driving” comprises driving with an arbitrary degree of automation. Automated driving can be provided in different degrees of automation, which correspond to SAE levels 1 to 5 of the standard SAE J3016.

In the present case, there is interest in particular in those driver assistance systems which enable at least highly automated driving. In highly automated driving (SAE level 3), the system takes over the longitudinal and lateral control in specific driving situations without the driver having to continuously monitor the system. The driver does have to be capable within a certain time, however, of taking over the vehicle control upon prompting by the system. In fully automated driving (SAE level 4), the system takes over the vehicle control in specific driving situations, even if the driver does not react to a prompt to intervene, so that the driver is omitted as a fallback level. In autonomous driving (SAE level 5), all aspects of the dynamic driving task can be carried out by the system under all roadway and surroundings conditions, which are also managed by a human driver.

For all active driving functions according to level 3 and higher, it is absolutely necessary to maintain a previously defined safe operating state. Such an operating state can also be referred to as the operational design domain (ODD). This means in particular that the vehicle having a driving function according to level 3 or higher can drive if the surroundings and the conditions match with the system design. If the system was only developed for defined system designs, for example, it cannot be the case that the driving function according to level 3 or higher is also activated with system designs which are not specified or predefined operating states.

In this context, DE 10 2013 222 048 A1 discloses a method for activating or deactivating an automatic driving function of a technical system for assisting the driver of a motor vehicle, which is referred to therein as a pilot. If specific requirements for maintaining the active pilot are no longer present, for example, the pilot can be deactivated or a driver warning can be output. This can be the case when a system limit is reached, for example, the system is only designed for specific road classes.

It is the object of the present invention to disclose a solution for how an at least highly automated driving mode of a vehicle can be provided more safely.

This object is achieved according to the invention by a method, by a computing device, by a driver assistance system, and by a computer product having the features according to the independent claims. Advantageous refinements of the present invention are specified in the dependent claims.

A method according to the invention is used for monitoring an at least highly automated driving mode of a vehicle. The method comprises activating the at least highly automated driving mode of the vehicle. In addition, the method comprises checking whether a predetermined safe operating state of the vehicle is provided during the at least highly automated driving mode. In addition, the method comprises initiating a deactivation of the at least highly automated driving mode if the predetermined safe operating state is not provided and maintaining the at least highly automated driving mode if the predetermined safe operating state is provided. Furthermore, the method comprises receiving at least one sensor signal which describes a vertical dynamic of the vehicle. In addition, the method comprises defining the safe operating state as a function of the at least one received sensor signal.

The method can be carried out using a corresponding computing device of the vehicle or a driver assistance system of the vehicle. This computing device can be formed by at least one electronic control unit. The at least highly automated driving mode of the vehicle can be controlled or monitored using this computing device. The term “at least highly automated driving mode” is to be understood as automated driving with a degree of automation according to level 3, level 4, or level 5. In other words, at least highly automated driving is to be understood as highly automated driving, fully automated driving, and autonomous driving.

During the at least highly automated driving mode of the vehicle, in particular it is continuously checked whether the safe operating state is provided. This safe operating state can be defined, for example, during the development of the driver assistance function or of the driver assistance system. This defined safe operating state can in particular describe the system design for which the driver assistance system was developed. If the safe operating state is fulfilled, it can be presumed that the journey with the vehicle in the highly automated driving mode is safe.

Multiple operating variables can be defined for this safe operating state. These operating variables can, on the one hand, describe the operation or driving status of the vehicle

CLEAN COPY itself. One operating variable can be the speed of the vehicle. For example, the automated driving mode from level 3 can only be permitted up to a maximum speed. Furthermore, these operating variables can also describe the surroundings of the vehicle. One operating variable can take into account the visibility conditions in the surroundings of the vehicle. For example, the automated driving from level 3 can only be permitted with certain visibility conditions. If it is recognized that the predetermined or defined safe operating state is provided, the driving mode according to level 3 or higher can be maintained. Otherwise, the deactivation of the at least highly automated driving mode can be initiated.

According to the present invention, it is provided that at least one sensor signal is received which describes a vertical dynamic of the vehicle. The vertical dynamic is to be understood in particular as forces, torques, and/or accelerations which act in the vertical direction of the vehicle. Furthermore, it is provided according to the invention that the safe operating state is defined as a function of the at least one received sensor signal. The vertical dynamic of the vehicle can be derived on the basis of the at least one sensor signal. Defined limiting values can be specified for this sensor signal or for the vertical dynamic of the vehicle, for example. If these limiting values with respect to the vertical dynamic are observed, the defined safe operating state can be considered to be fulfilled if the further operating variables for the safe operating state or the operational design domain (ODD) are also fulfilled at the same time. In this case, the at least highly automated driving function can be maintained. Vice versa, the ODD can be considered to be not fulfilled if the requirements with respect to the vertical dynamic are not fulfilled. The vertical dynamic can therefore be viewed as an indicator which clearly indicates when the safe operating state is fulfilled. However, it is not sufficient to only monitor the vertical dynamic for the monitoring of the safe operating state.

The present invention is based on the finding that at least highly automated driving systems or driver assistance systems in road traffic according to the current prior art for the civilian area are only permitted on defined roads or road classes. For example, the roads or the road classes can be tarred, concreted, or asphalted roads, which are accordingly level. In particular, the at least highly automated driving function can only be permitted on level surfaces. Accordingly, it cannot occur that level 3 systems still remain active when a “bumpy” journey is detected. When such a “bumpy” journey is present, this can be detected on the basis of the at least one sensor signal which describes the vertical dynamic. In this case, it can be presumed that the vehicle is located on a non-permitted road or road class or currently has at least partially departed from such a road or roadway.

It can be ensured by the evaluation of the at least one sensor signal which describes the vertical dynamic of the vehicle that an active system which enables an at least highly automated journey no longer remains active when driving on an impermissible road or upon departing from a permissible road. Because the safe operating state which is to be observed when driving according to automation level 3 and higher is defined on the basis of the vertical dynamic, the level of safety in the operation of the driver assistance system can be increased.

Preferably, the deactivation of the at least highly automated driving mode is initiated if a journey of the vehicle on a predetermined surface or roadway surface and/or a non-permitted road class is detected on the basis of the at least one sensor signal. As previously explained, it can be provided in particular that the operation of the vehicle with the degree of automation level 3 and higher is only permitted on asphalted roads or the like. If it is now detected on the basis of the at least one sensor signal that, for example, the vehicle is currently on an unfixed roadway, a gravel road, a grassy surface, or the like, the at least highly automated

CLEAN COPY driving mode can be deactivated. Furthermore, it can be the case that the at least highly automated driving mode is only permitted for defined road classes. If the system was only developed for freeways, for example, the driver assistance system for providing the highly automated driving mode can be activated when it is detected that the vehicle is on a country road, a road having inadequate roadway surface, or the like. The safety during at least highly automated driving can therefore be enabled in a simple manner.

In a further embodiment, the deactivation of the at least highly automated driving mode is initiated if a deviation of the vehicle from a roadway is detected on the basis of the at least one sensor signal. In order to ensure the safety during at least highly automated driving, it is preferably furthermore provided that a deviation of the vehicle from the road or the roadway is detected. The term “deviation” is understood in the present case in particular to mean that the vehicle deviates at least partially or with at least one wheel from the roadway. If the at least one wheel deviates from the road or the roadway, this can be detected on the basis of the at least one sensor signal or the vertical dynamic. Outside the roadway or the lane which is provided for the journey of the vehicle, for example, dirt and/or irregularities can be present, which can be detected by the increased vertical dynamic in comparison to the roadway. Furthermore, it can be the case if the vehicle deviates from the roadway that the vehicle drives over an unfixed edge area of the roadway, a shoulder, a gravel surface, or a turf. This can also be detected on the basis of the at least one sensor signal. The at least highly automated driving function can also be deactivated in this case and the driving task can be transferred to the driver. Alternatively or additionally, it can be provided that automated braking is initiated in order to bring the vehicle to a standstill in a safe area.

In a further embodiment, the at least one sensor signal describes a spring deflection of a shock absorber of the vehicle, an acceleration, and/or an area of the surroundings of the vehicle acquired using a surroundings sensor. For example, the at least one sensor signal can describe a spring deflection or a suspension travel of a shock absorber of a chassis of the vehicle. In this case, the sensor signal can be provided using a chassis sensor. Moreover, the at least one sensor signal can describe the acceleration and in particular the acceleration in the vehicle vertical direction. This acceleration can be acquired, for example, using a corresponding acceleration sensor. Alternatively or additionally, it can be provided that the vertical dynamic of the vehicle is acquired on the basis of a sensor signal of a surroundings sensor of the vehicle. This surroundings sensor can acquire, for example, an area of the surroundings of the vehicle. During the acquisition of the surrounding area or an object in the surrounding area, corresponding pitching movements of the vehicle, which represent the vertical dynamic of the vehicle, can be detected. The surroundings sensor can be, for example, a camera, a radar sensor, a lidar sensor, or the like. The vertical dynamic of the vehicle can be determined in a simple and reliable manner on the basis of these sensor signals.

Furthermore, it is advantageous if the at least one sensor signal describes a time series and the sensor signal is compared to at least one predetermined signal pattern to check the safe operating state. In the present case, it is thus provided in particular that not only individual sensor values are acquired and compared to a limiting value. In particular, an if-then query is not to be carried out on the basis of individual sensor values. Rather, it is provided according to the present invention that a time series of the sensor signal is acquired and the time profile of the sensor signal is evaluated. The time series can comprise a chronological sequence of acquired sensor values. In particular, the time series of the sensor signal can be compared to a predetermined signal pattern.

It is provided in particular in this case that the at least one predetermined signal pattern describes the vertical dynamic of the vehicle during a journey on a road having a certain road class. In other words, the predetermined signal pattern can describe the vertical dynamic or the at least one sensor signal during the journey on an asphalted, tarred, or concreted road. Such signal patterns, in which the vehicle is moved on a road permitted for the at least highly automated driving are typically present in large numbers or were determined in the preparation for many driving experiments. These signal patterns can therefore be considered to be valid. These signal patterns describe the operating variable to be fulfilled or the safe operating state. If a deviation from such a signal pattern is detected, it can be presumed that the safe operating state is currently not present. In this case, methods of machine learning, neural networks, or the like can also be used in order to compare the at least one sensor signal to the predetermined signal pattern. A learning system can therefore more or less be provided, using which it is detected on the basis of the at least one sensor signal whether or not the safe operating state is present for the at least highly automated driving.

In a further embodiment, to initiate the deactivation of the at least highly automated driving mode, a takeover request is output to a driver of the vehicle. During the operation according to level 3, it is necessary for the attention of the driver to be directed back onto the traffic events and/or to transfer to the driver. Corresponding takeover requests can be output for this purpose. In principle, these takeover requests can be output acoustically, optically, and/or haptically. Multiple escalation steps can preferably also be provided here. For example, initially an optical warning can be output and if this is not perceived by the driver, an acoustic warning can alternatively or additionally be output. It is therefore possible for the driver to take over the control of the vehicle again in a timely manner safely.

Furthermore, it can also be provided that an intervention is made in the longitudinal control and/or lateral control of the vehicle by means of the driver assistance system. This can be the case in particular if the driver has not reacted to the above-described takeover request. In this case, for example, emergency braking can be initiated or the vehicle can be maneuvered into a safe area. For example, if it was detected that the vehicle has departed from the roadway, an intervention can be made in the lateral control such that the vehicle is steered back onto the roadway.

To initiate the deactivation of the at least highly automated driving mode during operation according to level 4, it is also possible to hand over to the driver. However, the driver assistance system cannot rely on a takeover in this case. It is therefore preferably provided that a safe operating state, such as a standstill, is independently induced by the driver assistance system. During operation according to level 5, a safe operating state has to be started independently by the driver assistance system to initiate the deactivation of the autonomous driving mode.

A computing device according to the invention for a driver assistance system of a vehicle is configured to carry out a method according to the invention and the advantageous embodiments thereof. The computing device can be formed by at least one electronic control unit of the vehicle. The computing device can have at least one processor and a memory.

A driver assistance system according to the invention for a vehicle comprises a computing device according to the invention. The driver assistance system is configured to maneuver the vehicle at least in a highly automated manner here. The driver assistance system can furthermore have a sensor, using which the at least one sensor signal can be provided that describes the vertical dynamic of the vehicle. The at least one sensor can be a chassis sensor, an acceleration sensor, and/or a surroundings sensor of the vehicle.

A vehicle according to the invention comprises a driver assistance system according to the invention. The vehicle is designed in particular as a passenger vehicle.

A further aspect of the invention comprises a computer program, comprising commands which, upon the execution of the program by a computing device, prompt it to carry out a method according to the invention and the advantageous embodiments thereof. Furthermore, the invention relates to a computer-readable (storage) medium, comprising commands which, upon the execution by a computing device, prompt it to carry out a method according to the invention and the advantageous embodiments thereof.

The preferred embodiments presented with reference to the method according to the invention and the advantages thereof apply accordingly to the computing device according to the invention, to the driver assistance system according to the invention, to the vehicle according to the invention, to the computer program according to the invention, and to the computer-readable (storage) medium according to the invention.

Further features of the invention result from the claims, the figures, and the description of the figures. The features and combinations of features mentioned above in the description and the features and combinations of features mentioned hereinafter in the description of the figures and/or shown solely in the figures are usable not only in the respective specified combination, but also in other combinations or alone, without departing from the scope of the invention.

The invention will now be explained in more detail on the basis of preferred exemplary embodiments and with reference to the appended drawings.

### BRIEF DESCRIPTION OF THE DRAWINGS

FIG. 1 shows a schematic representation of a vehicle which comprises a driver assistance system; and

FIG. 2 shows the vehicle according to FIG. 1, which is located on a roadway, wherein the vehicle is currently departing from the roadway.

In the figures, identical or functionally-identical elements are provided with identical reference signs.

### DETAILED DESCRIPTION OF THE DRAWINGS

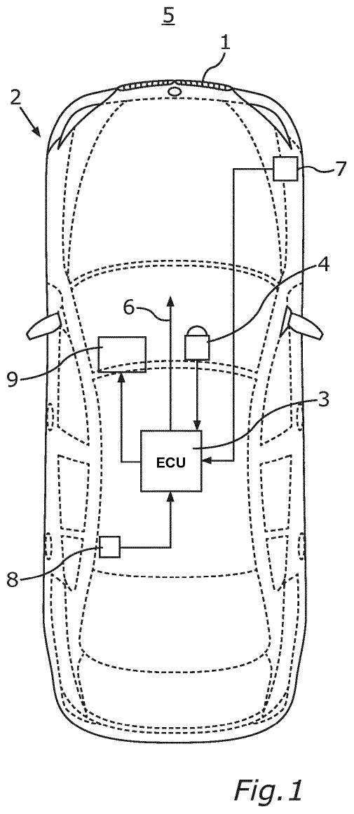

FIG. 1 shows a schematic representation of a vehicle 1, which is designed as a passenger vehicle, in a top view. The vehicle 1 comprises a driver assistance system 2, which is used to assist a driver or user of the vehicle 1 in the control of the vehicle 1.

The driver assistance system 2 comprises a computing device 3, which can be formed, for example, by at least one electronic control unit of the vehicle 1. An at least highly automated driving mode of the vehicle 1 can be enabled by means of the driver assistance system 2. This means that the vehicle can be operated in a highly automated driving mode according to level 3, a fully automated driving mode according to level 4, and/or an autonomous driving mode according to level 5.

The driver assistance system 2 moreover comprises a surroundings sensor 4, which is designed in the present case as a camera. Data which describe the surroundings 5 of the vehicle 1 can be provided using this surroundings sensor 4. These data can be transmitted to the computing device 3. In principle, it is provided that the driver assistance system 2 comprises a plurality of surroundings sensors or different types of surroundings sensors 4. Corresponding interventions in the longitudinal control and the lateral control of the vehicle 1 can then be performed on the basis of the data of the surroundings sensors 4. This is illustrated solely as an example in the present case by the arrow 6.

In addition, the driver assistance system 2 comprises a chassis sensor 7, by means of which a spring deflection of a damper or shock absorber of the vehicle 1 can be detected. In the present case, one chassis sensor 7 is shown for the sake of clarity. In principle, it is preferably provided that the driver assistance system 2 or the vehicle 1 has a plurality of chassis sensors 7. In addition, the driver assistance system 2 comprises an acceleration sensor 8, by means of which at least one acceleration in the vehicle vertical direction can be ascertained.

The computing device 3 can determine a vertical dynamic of the vehicle on the basis of the sensor signal of the chassis sensor 7 and the acceleration sensor 8. Moreover, it is provided that the computing device 3 can determine the vertical dynamic of the vehicle on the basis of the sensor data of the surroundings sensor 4. If, for example, a specific area and/or an object is continuously detected in the surroundings 5, repeated pitching movements of the vehicle 1 can be recognized on the basis of the sensor data of the surroundings sensor 4.

In addition, the driver assistance system 2 comprises an output device 9, by means of which warnings, requests, or instructions can be output to the driver or user of the vehicle 1. These instructions can be output, for example, acoustically, haptically, and/or optically. In particular, it is provided that by means of the output device 9, a takeover request can be output to the driver or user of the vehicle 1.

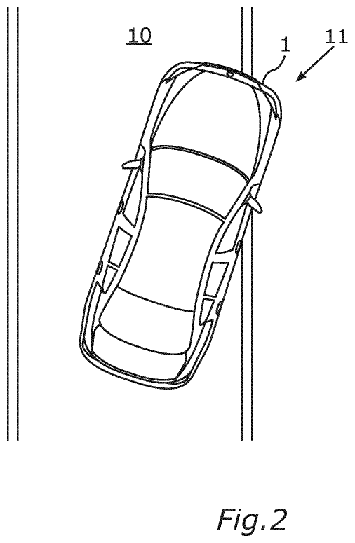

FIG. 2 shows a schematic representation of the vehicle 1, which is located on a roadway 10. In the driving situation shown in the present case, the vehicle 1 is departing from the roadway 10. In the present case, the front right wheel of the vehicle 1 has departed from the roadway 10 and is located at least partially on an area 11 which can be a dirt area adjacent to the roadway 10, an unfixed area, a shoulder, a turf, or the like. This departure from the roadway 10 by the vehicle 1 can be detected on the basis of the sensor signals of the sensors 4, 7, and/or 8.

A safe operating state is defined for the at least highly automated driving mode of the vehicle 1. When this safe operating state is fulfilled, the at least highly automated driving mode of the vehicle 1 according to level 3 and higher can be maintained. Otherwise, a deactivation of the highly automated driving mode can be initiated and, for example, a corresponding takeover request can be output to the driver or user.

In the present case, it is provided that this safe operating state, in addition to further operating variables, which can describe, for example, driving functions of the vehicle itself and/or the surroundings 5, comprises the vertical dynamic of the vehicle 1. In other words, it is necessary for the vertical dynamic of the vehicle 1 not to exceed a defined range since otherwise the at least highly automated driving function is to be deactivated. In order to be able to check the presence of the safe operating state, the sensor signals of the sensors 4, 7, and/or 8 can be compared to predetermined signal patterns. These predetermined signal patterns can describe, for example, the state in which the vehicle is moved on an asphalted, tarred, and/or concreted roadway. If a deviation from these signal patterns is recognized, the deactivation of the at least highly automated driving function can be initiated.

In the example shown in FIG. 2, the departure from the roadway 10 by the vehicle 1 can be recognized on the basis of the vertical dynamic. In this case, a takeover request can be output to the driver or user of the vehicle 1 by means of the output device 9. Alternatively or additionally, it can be provided that an intervention is made in the lateral control of the vehicle by means of the driver assistance system, so that the vehicle 1 is steered back completely onto the roadway 10 again. The safety in the at least highly automated driving mode of the vehicle can thus be ensured overall.

1.-10. (canceled)

11. A method for monitoring an at least highly automated driving mode of a vehicle, the method comprising the steps of:
activating the at least highly automated driving mode of the vehicle;
checking whether a defined safe operating state of the vehicle is provided during the at least highly automated driving mode;
initiating a deactivation of the at least highly automated driving mode when the defined safe operating state is not provided; and
maintaining the at least highly automated driving mode when the defined safe operating state is provided, wherein
the method receives at least one sensor signal which describes a vertical dynamic of the vehicle, and
defines the safe operating state as a function of the at least one received sensor signal.

12. The method according to claim 11, wherein
activating the at least highly automated driving mode is initiated if a journey of the vehicle on a predetermined surface and/or a non-permitted road class is recognized based on the at least one sensor signal.

13. The method according to claim 11, wherein
deactivating the at least highly automated driving mode is initiated if a deviation of the vehicle from a roadway is recognized based on the at least one sensor signal.

14. The method according to claim 11, wherein
the at least one sensor signal describes a spring deflection of a shock absorber of the vehicle, an acceleration, and/or a surrounding area of the vehicle detected using a surroundings sensor.

15. The method according to claim 11, wherein
the at least one sensor signal describes a time series, and the sensor signal is compared to at least one predetermined signal pattern to check the safe operating state.

16. The method according to claim 15, wherein
the at least one predetermined signal pattern describes the vertical dynamic of the vehicle during a journey on a road having a specific road class.

17. The method according to claim 11, wherein
to initiate the deactivating of the at least highly automated driving mode, a takeover request is output to a driver of the vehicle.

18. A computing device for a driver assistance system of a vehicle, comprising:
one or more processors and associated memory operatively configured to:
activate an at least highly automated driving mode of the vehicle;
check whether a defined safe operating state of the vehicle is provided during the at least highly automated driving mode;
initiate a deactivation of the at least highly automated driving mode when the predetermined safe operating state is not provided, and
maintain the at least highly automated driving mode when the predetermined safe operating state is provided,
wherein the safe operating state is defined by:
receiving at least one sensor signal which describes a vertical dynamic of the vehicle, and
defining the safe operating state as a function of the at least one received sensor signal.

19. A driver assistance system for a vehicle, comprising:
a computing device according to claim 18,
wherein the driver assistance system is configured for maneuvering the vehicle at least in a highly automated manner.

20. A computer product comprising a non-transitory computer readable medium having program code stored thereon which, upon execution of the program code by a computing device, carries out the acts of:
activating the at least highly automated driving mode of the vehicle;
checking whether a defined safe operating state of the vehicle is provided during the at least highly automated driving mode, wherein the defined operating state is a function of at least one sensor signal which describes a vertical dynamic of the vehicle;
initiating a deactivation of the at least highly automated driving mode when the defined safe operating state is not provided; and
maintaining the at least highly automated driving mode when the defined safe operating state is provided.
